(19) United States
(12) Patent Application Publication
(10) Pub. No.: US 2025/0353714 A1
(43) Pub. Date: Nov. 20, 2025

(54) MULTIFUNCTIONAL TRANSFER ROBOT

(71) Applicant: Amos Fluid Technology Co., Ltd., Xuancheng City, Anhui Province (CN)

(72) Inventors: Kang YAN, Xuancheng City, Anhui Province (CN); Haiqing MEI, Xuancheng City, Anhui Province (CN)

(21) Appl. No.: 18/871,569

(22) PCT Filed: May 24, 2023
(86) PCT No.: PCT/CN2023/096120

§ 371 Date: Dec. 4, 2024

(30) Foreign Application Priority Data
Jun. 6, 2022 (CN) 202210633776.1

(51) Int. Cl. B66F 9/06; B66F 9/075; B66F 9/08; B66F 9/12; B66F 9/18

(52) U.S. Cl. CPC B66F 9/063; B66F 9/07577; B66F 9/08; B66F 9/122; B66F 9/182

(57) ABSTRACT

A multifunctional transfer robot, which relates to the technical field of robots, and addresses the problem that the function of existing transfer robots is singular. The multifunctional transfer robot comprises a traveling unit, which is provided with a support; a base which is arranged on the support, a lifting unit capable of driving the base to ascend and descend in the height direction being arranged between the support and the base; a bearing seat which is used for bearing materials and arranged on the base; and a hoisting unit which is used for hoisting materials and arranged on the support.

### TECHNICAL FIELD

The present invention belongs to the technical field of robots, and in particular, relates to a multifunctional transfer robot.

### BACKGROUND

Some dangerous environments which are inflammable, explosive, prone to electric shock and prone to cause geological disasters will be encountered in the emergency rescue emission. At this time, ordinary transport vehicles cannot be used, and it is necessary to use manually carry rescue supplies or equipment. On one hand, manual transfer requires huge physical expenditure; and on the other hand, manual transfer also faces the great threat that may be brought by secondary disasters to life.

To solve the problem, a transfer robot can be used to transport relief materials instead of manual transfer, and the robot is remotely controlled to travel to a target place to transport the relief materials to the target location. Therefore, it is necessary to develop a transfer robot with a heavy load, convenient to load and unload, capable of traveling automatically and suitable for all-terrain work, so as to reduce staff, reduce the emergency rescue risk and improve the emergency rescue efficiency.

According to a transfer robot provided by the China patent (with the authorization publication number CN215479486U) submitted by the applicant the prior art, a lifting unit is arranged on the robot, so that materials in dangerous environments can be loaded and unloaded, and the transfer robot is suitable for the complicated working environments of emergency rescue. This patent can solve the transfer problem of emergency materials in dangerous environments, but cannot work when being involved in the requirement of carrying a water pump to perform water intake or drainage. In view of this defect, another China patent (with the publication number CN113815739A) submitted by the applicant discloses a drainage robot, so as to achieve the remote drainage function in dangerous environments. The patents respectively disclose robots in different application scenarios, but in a case that the rescue scenarios faced by the robots are diversified, it is necessary to use different robots to complete the work. In particular, for high-position fetching and vertical water intake and drainage work on bridges and tunnels, the two robots cannot implement rescue. Therefore, it is urgent to put forward a rescue robot with higher applicability.

### SUMMARY

An objective of the present invention is to provide a multifunctional transfer robot for the above problems in the prior art.

The objective of the present invention can be achieved by the following technical solution: a multifunctional transfer robot includes a traveling unit, where a support is arranged on the traveling unit;
a base is arranged on the support, and a lifting unit capable of driving the base to ascend and descend in a height direction is arranged between the support and the base;
a bearing seat for bearing materials is arranged on the base; and
a winch is further arranged on the support, and the winch is arranged at one end of the support away from the bearing seat.

In the multifunctional transfer robot, a pulling rope is arranged on the winch, one end of the pulling rope is wound on the winch, the other end of the pulling rope is provided with a hoisting portion, the bearing seat is provided with a pivot, and the pulling rope passes through or goes around the pivot to be connected to the hoisting portion.

The winch is arranged at one end of the support away from the bearing seat, so that the center of gravity of the winch is placed at the back, and the center of gravity is balanced when a heavy object is placed on the bearing seat; and the pivot is arranged on the bearing seat, so that the center of gravity of the pulling rope is located below the pivot when goods are hoisted, and the pivot is located at an outer end of the bearing seat, thereby ensuring that the goods can move up and down along a part under the pivot during hoisting, and preventing the goods from interfering with the traveling unit.

As another solution, a water hose is arranged on the winch, one end of the water hose is wound on the winch, and the other end of the water hose is a free end. The water hose is arranged on the winch, so that the winch can drive the water hose to form a pipe arrangement robot for performing pipe arrangement during drainage and recover the water hose after the operation is completed.

In the multifunctional transfer robot, the hoisting portion is a lifting hook, a lifting ring, a binding rope or a cable tie.

In the multifunctional transfer robot, the traveling unit includes a traveling mechanism and a power mechanism for driving the traveling mechanism to move, the power mechanism is a motor, a hydraulic motor or an internal combustion engine, and the traveling mechanism is a crawler type traveling chassis or a tyre type traveling chassis.

The traveling unit has power, which may be electric and hydraulic driving or may be internal combustion engine driving, so as to control the robot to move to a specified emergency position.

In the multifunctional transfer robot, the lifting unit includes guide rails arranged on the support and a lifting mechanism for driving the base to move up and down along the guide rails.

In the multifunctional transfer robot, the lifting mechanism includes a hydraulic cylinder, a piston of the hydraulic cylinder is fixedly connected to the base, and a hydraulic cylinder mounting base is arranged on the support.

In the multifunctional transfer robot, the lifting mechanism includes a motor, and a screw rod arranged on a motor output shaft; a nut embedded into the screw rod is arranged on the base; and a motor mounting base is arranged on the support.

In the multifunctional transfer robot, two groups of guide rails are respectively arranged on two sides of the support, and a guide piece embeddable in the guide rails is arranged on the base.

In the multifunctional transfer robot, each of the guide rails is a foldable guide rail and includes a first track connected to the base and a second track hinged with the first track, a limiting piece for limiting when the second track is turned over to be docked with the first track is arranged between the first track and the second track, guide grooves are formed in the first track and the second track, and the guide groove in the second track is docked with the guide groove in the first track when the second track is turned over to be docked with the first track. By the multi-section foldable guide rails, the lifting height of the base can be increased without affecting the overall height of the robot; the docking state of the first track and the second track is locked by the limiting piece, so that the first track can be prevented from being separated from the second track during guidance; and when the base is recovered, the locking of the first track and the second track is relieved, and the second track can be turned over to be attached to the first track, so that the overall height of the guide rails can be reduced.

In the multifunctional transfer robot, the bearing seat includes a bearing rod arranged on the base, one end of the bearing rod is fixedly connected to the base, and the other end of the bearing rod is provided with an electromagnet.

The bearing seat is a stress end for gravity bearing of main materials, which may be a bearing plate or may be a bearing rod. The electromagnet is configured to adsorb and desorb magnetically attractable goods by energizing and de-energizing the electromagnet.

In the multifunctional transfer robot, a multi-stage telescopic mechanism is arranged on the bearing rod, the multi-stage telescopic mechanism includes a telescopic rod arranged on the bearing rod away from a fixed end, the telescopic rod is capable of extending forward or retracting backward in an extending direction of the bearing rod, and the multi-stage telescopic mechanism further includes a telescopic power module arranged on the bearing rod.

In the multifunctional transfer robot, the telescopic power module includes a hydraulic cylinder arranged on the bearing rod, and an output shaft of the hydraulic cylinder is connected to a telescopic rod.

In the multifunctional transfer robot, the telescopic rod is provided with a goods fixing hole. The goods fixing hole is configured to bind goods or fix goods with bolts.

In the multifunctional transfer robot, the telescopic power module further includes a limiting block arranged on the telescopic rod.

In the multifunctional transfer robot, the limiting block includes a supporting block and a centering block arranged on the supporting block, a front part of the centering block is conical or arc-shaped, and the supporting block is larger than the centering block. The supporting block is larger than the centering block, thereby facilitating the bearing of the goods; and the front part of the centering block is conical or arc-shaped, thereby facilitating guidance when the goods are inserted.

In the multifunctional transfer robot, an electromagnet is arranged on the supporting block. The electromagnet can be energized and de-energized to implement adsorption and separation of magnetic goods or iron goods by the supporting block. In particular, the hoisting unit is formed after the pulling rope is arranged on the winch, the goods are adsorbed before hoisting so as to facilitate the positioning of the goods, the electromagnet can be de-energized when the goods are hoisted by the hoisting unit and the weight of the goods is offset by a lifting force of the hoisting unit. At this time, the goods are not adsorbed by the supporting block and are stressed completely through the hoisting unit, then the telescopic rod can be recovered, and the goods are put down slowly by the hoisting unit, so that the influence on the stability of the hoisting unit by the weightlessness of the goods caused by direct falling of the goods when the telescopic rod is directly recovered can be avoided. The hoisting unit has a stall protection function, so deviation of the center of gravity will not be generated in the hoisting process.

In the multifunctional transfer robot, the pulling rope adopts multiple sections, which are respectively wound on the winch. The multi-section pulling rope is provided, so that after the goods are hoisted to a specific place, the pulling rope is released, one end of the pulling rope is connected to the goods, and the other end of the pulling rope can be fixed on a bridge deck or float on the water, thereby positioning the pulling rope. When it is necessary to recover the goods, the telescopic rod or the hoisting unit can hook up or suck up the recovering portion of the pulling rope, thereby recovering the pulling rope to the winch and hoisting the goods from a lower place after the winch is reversed.

As another solution, a lock hook for docking goods is arranged on the pulling rope. The goods are bound by the lock hook when the goods are hoisted, a hoisting force on the pulling rope is released after the goods are hoisted to a set position, and the lock hook can be automatically separated from the goods. When it is necessary to hoist the goods again, it is only necessary to make the pulling rope fall on a stress point of the goods, and the goods can be hoisted.

In the multifunctional transfer robot, an end part of the pulling rope extends out of the bearing seat.

In the multifunctional transfer robot, a guide wheel for guiding the pulling rope is arranged on the base and/or the bearing rod.

In the multifunctional transfer robot, a baffle for preventing materials from falling off is further arranged on the base.

The hoisting unit on the bearing rod is configured to hoist materials through the winch, thereby facilitating the downward hoisting of materials on a bridge or a high-rise for underwater operation or aloft work. Due to the design of the hoisting unit, the rescue scenario of the robot is further expanded. In particular, for emergency water intake or fire-fighting water intake of the bridge deck, a water pump can be directly hoisted to the underwater operation. Furthermore, a plurality of water pumps can be carried back and forth. Compared with the original integrated robot and water pump, the application range is wider, the cost is lower, and the function of carrying materials is not affected.

Another objective of the present invention is to provide a hoisting method of a multifunctional transfer robot, including the following steps:
S1: firstly, through traveling of a traveling unit, locating an electromagnet on a bearing rod below a hoisted material, energizing the electromagnet, and descending the bearing rod through the ascending and descending of a lifting mechanism until the electromagnet adsorbs the hoisted material;
S2: fixing a hoisting portion on the hoisted material to fix the hoisted material;
S3: rotating a winch until a pulling rope tightens the hoisted material;
S4: after transporting the hoisted material to a working area by the traveling unit, lifting the hoisted material by the lifting mechanism in a height direction until the hoisted material is higher than an obstacle;
S4: extending a telescopic mechanism, so that the hoisted material extends forward in a plane direction to cross the obstacle;
S5: rotating the winch, and after the pulling rope tightens the hoisted material again, de- energizing the electromagnet, where the gravity of the hoisted material is borne by the pulling rope at this time;

S6: driving the pulling rope by the winch to move down to make the hoisted material fall to a rescue area;
S7: after the falling of the hoisted material is completed, urgently requiring the lower pulling rope to be separated from the winch to complete hoisting, where the pulling rope on the winch is longer than the height difference of the rescue area; and
S8: recovering the telescopic mechanism, descending the lifting unit, and conveying the robot by the traveling unit to a next station for use.

In the hoisting method of the multifunctional transfer robot, the pulling rope is segmented, and one end of the pulling rope away from the hoisting portion is provided with a recovering portion. Before use, the height of the pulling rope is preset according to the height of an area to be rescued. The recovering portion is arranged on one side of the pulling rope away from the hoisting portion. The recovering portion may be configured to be hung on an obstacle, or may directly float on the water surface, so that the robot can adsorb the recovering portion conveniently when recovering the hoisted materials and enter the winch again.

In the hoisting method of the multifunctional transfer robot, the hoisting method further includes a recovering step as follows:
S9: driving the robot by the traveling unit to enter a recovering area, lifting the lifting mechanism, extending the telescopic mechanism, and moving down the pulling rope by the winch;
S10: after the hoisting portion on the pulling rope is in contact with the recovering portion on the hoisted material, fixing the recovering portion on the hoisting portion through strong magnetic adsorption or a lifting hook, then recovering the winch, rewinding the recovering portion on the winch, energizing the electromagnet after lifting the hoisted material to the bearing rod, and making the hoisted material re-adsorbed on the electromagnet; and
S11: recovering the telescopic mechanism, descending the lifting unit, and transporting the hoisted material by the traveling unit to an initial position to complete the recovery of the hoisted material.

Compared with the prior art, the present invention has the following advantages: a traveling mechanism is provided, so that unmanned operation of carrying emergency rescue materials is implemented; the lifting unit and the telescopic mechanism are provided, so that the transport specification of transport relief materials is expanded; the winch is provided for hoisting or pipe arrangement, and is conveniently applied to carrying occasions with a large height difference; and the robot can be reused, thereby facilitating the multi-thread operation of one robot and improving the loading efficiency.

### BRIEF DESCRIPTION OF THE DRAWINGS

FIG. 1 is a schematic diagram of a three-dimensional structure of the present invention;

FIG. 2 is a schematic diagram of a three-dimensional structure of the present invention from another perspective;

FIG. 3 is a reference diagram of a use state of a lifting unit according to the present invention;

FIG. 4 is a reference diagram of a use state of a guide rail according to the present invention;

FIG. 5 is a reference diagram of a retracted state of a telescopic mechanism according to the present invention; and

FIG. 6 is a reference diagram of an extending state of a telescopic mechanism according to the present invention.

In the drawings, 1. traveling unit; 11. power mechanism; 2. support; 3. base; 31. baffle; 4. lifting unit; 41. guide rail; 42. lifting mechanism; 43. hydraulic cylinder mounting base; 44. limiting piece; 45. first track; 46. second track; 51. bearing seat; 52. bearing rod; 53. telescopic rod; 54. telescopic power module; 55. goods fixing hole; 56. limiting block; 57. centering block; 58. supporting block; 6. winch; 61. pulling rope; 62. hoisting portion; 63. guide wheel.

### DETAILED DESCRIPTION

The technical solutions of the present invention are further described below with reference to the specific embodiments of the present invention and in conjunction with the accompanying drawings, however, the present invention is not limited to these embodiments.

The multifunctional transfer robot is mainly applied to occasions in which people cannot get close to under the rescue and emergency occasion, and mainly includes a traveling unit 1, where a support 2 is arranged on the traveling unit 1; a base 3 is arranged on the support 2, and a lifting unit 4 capable of driving the base 3 to ascend and descend in a height direction is arranged between the support 2 and the base 3; a bearing seat 51 for bearing materials is arranged on the base 3; and a winch 6 is further arranged on the support 2, and the winch 6 is arranged at one end of the support 2 away from the bearing seat 51, thereby maintaining the balance of the center of gravity. The multifunctional transfer robot can be combined with working objects to form various use scenarios, including but not limited to: 1. the robot carries the water pump through the bearing seat 51 to a specified place to form a water supply and drainage robot; 2. the robot is provided with the water hose on the winch 6, the winch 6 rotates during transportation of the robot, and the water hose is released to form a pipe arrangement robot in the water supply and drainage process; 3. the robot ascends and descends the bearing seat 51 through the lifting action of the lifting unit 4 to form a three-dimensional forklift function in the rescue and emergency scenario, and the materials are carried and stacked or retrieved; 4. The robot is combined with the winch 6 of the pulling rope 61 to form a small vertical lifting crane for water intake or drainage on the high-altitude bridge deck, the winch 6 drives the pulling rope 61 to be responsible for hoisting the materials, and the lifting unit 4 is responsible for crossing the obstacles on the bridge deck; and 5. the robot is combined with a pulling rod to form a pulling engine for operation or rescue in marshes.

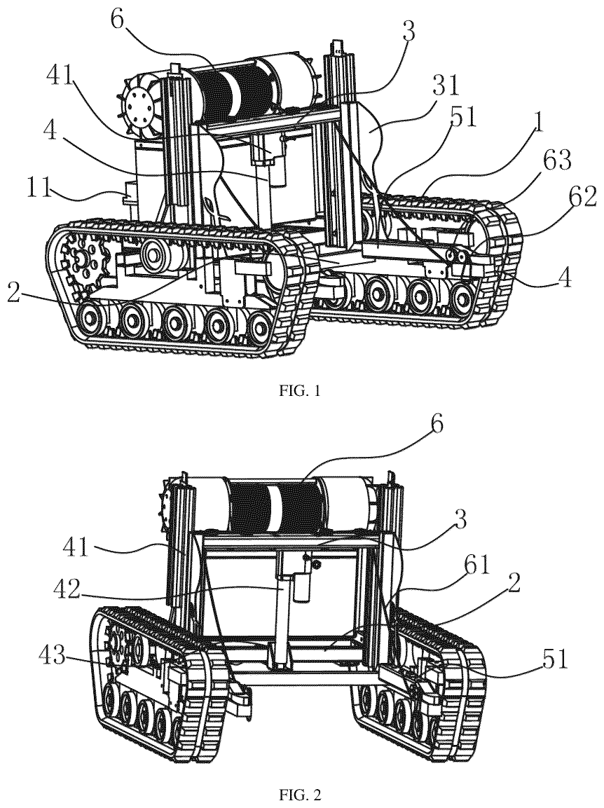

Specifically, this embodiment mainly provides an application scenario applied to overhead hoisting, as shown in FIG. 1 to FIG. 3, besides the traveling unit 1, the lifting unit 4 and the bearing seat 51, the pulling rope 61 is arranged on the winch 6, one end of the pulling rope 61 is wound on the winch 6, the other end of the pulling rope is provided with a hoisting portion 62, a pivot is arranged on the bearing seat 51, and the pulling rope 61 passes through or goes around the pivot to be connected to the hoisting portion 62. The winch 6 is arranged at one end of the support 2 away from the bearing seat 51, so that the center of gravity of the winch 6 is placed at the back, and the center of gravity is balanced when a heavy object is placed on the bearing seat 51; and the pivot is arranged on the bearing seat 51, so that the center of gravity of the pulling rope 61 is located below the pivot when goods are hoisted, and the pivot is located at an outer end of the bearing seat 51, thereby ensuring that the goods can move up and down along a part under the pivot during hoisting, and preventing the goods from interfering with the traveling unit 1.

The traveling unit 1 includes a traveling mechanism and a power mechanism 11 for driving the traveling mechanism to move, the power mechanism 11 is a motor, a hydraulic motor or an internal combustion engine, and the traveling mechanism is a crawler type traveling chassis or a tyre type traveling chassis. The traveling unit 1 has power, which may be electric and hydraulic driving or may be internal combustion engine driving, so as to control the robot to move to a specified emergency position. This embodiment adopts an electric motor, power is provided by the electric motor, and the power is output to a crawler or a tyre for traveling operation.

As shown in FIG. 3, the lifting unit 4 includes guide rails 41 arranged on the support 2 and a lifting mechanism 42 for driving the base 3 to move up and down along the guide rails 41; and the lifting mechanism 42 includes a hydraulic cylinder, a piston of the hydraulic cylinder is fixedly connected to the base 3, and a hydraulic cylinder mounting base 43 is arranged on the support 2. Two groups of guide rails 41 are respectively arranged on two sides of the support 2, and a guide piece embeddable in the guide rails 41 is arranged on the base 3.

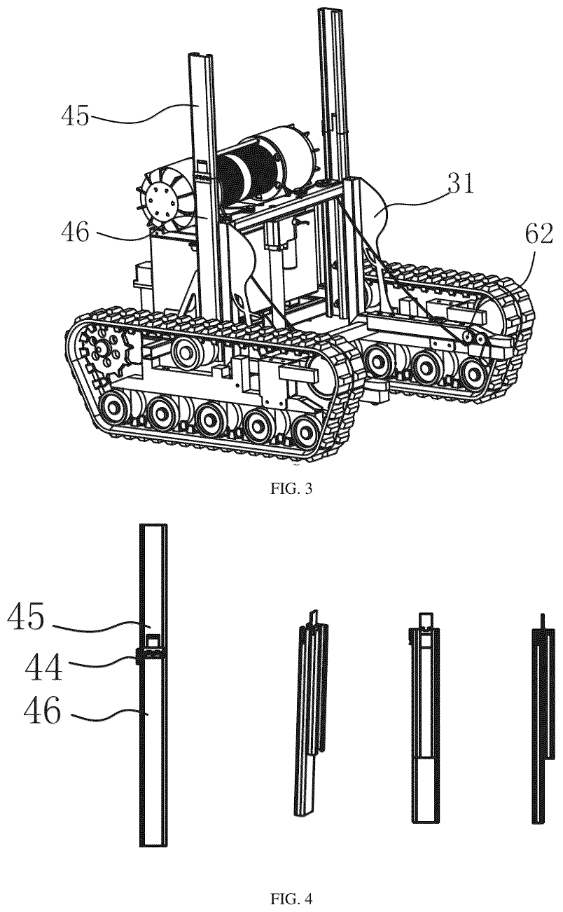

As shown in FIG. 4, each of the guide rails 41 is foldable and includes a first track 45 connected to the base 3 and a second track 46 hinged with the first track 45, a limiting piece 44 for limiting when the second track 46 is turned over to be docked with the first track 45 is arranged between the first track 45 and the second track 46, guide grooves are formed in the first track 45 and the second track 46, and the guide groove in the second track 46 is docked with the guide groove in the first track 45 when the second track 46 is turned over to be docked with the first track 45; by the multi-section foldable manner, the lifting height of the base 3 can be increased without affecting the overall height of the robot; the docking state of the first track 45 and the second track 46 is locked by the limiting piece 44, thereby preventing the first track 45 from being separated from the second track 46 during guidance; and when the base 3 is recovered, the locking of the first track 45 and the second track 46 is relieved, and the second track 46 can be turned over to be attached to the first track 45, so that the overall height of the guide rails 41 can be reduced.

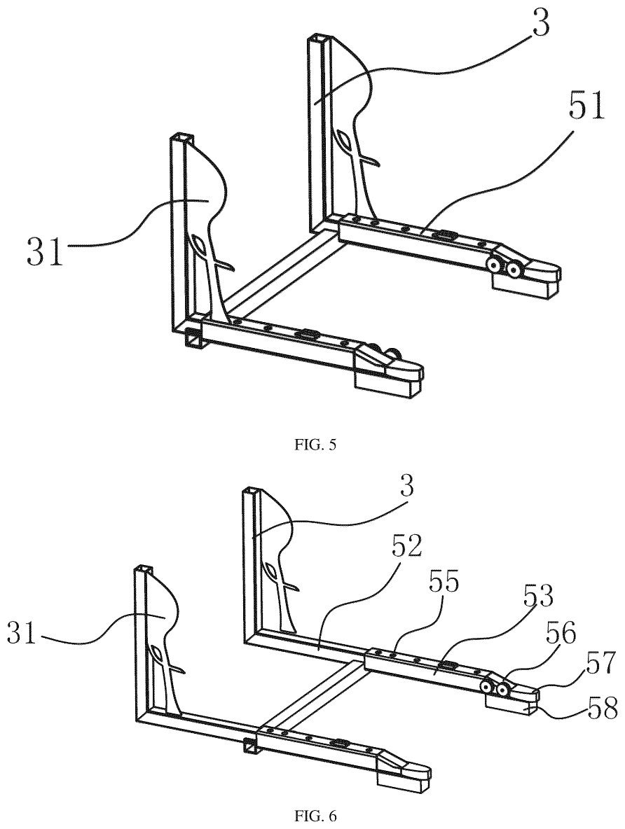

As shown in FIG. 5, in the multifunctional transfer robot, the bearing seat 51 includes a bearing rod 52 arranged on the base 3, one end of the bearing rod 52 is fixedly connected to the base 3, and the other end of the bearing rod is an action end. The bearing seat 51 is a stress end for gravity bearing of main materials, which may be a bearing plate or may be a bearing rod 52.

In this embodiment, a multi-stage telescopic mechanism is arranged on the bearing rod 52, the multi-stage telescopic mechanism includes a telescopic rod 53 arranged on the bearing rod 52 away from a fixed end, the telescopic rod 53 can extend forward or retract backward in an extending direction of the bearing rod 52, the multi-stage telescopic mechanism further includes a telescopic power module 54 arranged on the bearing rod 52, the telescopic power module 54 includes a hydraulic cylinder arranged on the bearing rod 52, and an output shaft of the hydraulic cylinder is connected to the telescopic rod 53.

To further facilitate the loading and unloading of goods, the telescopic rod 53 is provided with a goods fixing hole 55. The goods fixing hole 55 is configured to bind goods or fix goods with bolts. The telescopic power module 54 further includes a limiting block 56 arranged on the telescopic rod 53, the limiting block 56 includes a supporting block 58 and a centering block 57 arranged on the supporting block 58, a front part of the centering block 57 is conical or arc-shaped, the supporting block 58 is larger than the centering block 57, and an electromagnet is arranged on the supporting block 58. The electromagnet can be energized and de-energized to implement adsorption and separation of magnetic goods or iron goods by the supporting block 58. In particular, the goods are adsorbed before hoisting so as to facilitate the positioning of the goods, the electromagnet can be de-energized when the goods are hoisted by the hoisting unit and the weight of the goods is offset by a lifting force of the hoisting unit. At this time, the goods are not adsorbed by the supporting block 58 and are stressed completely through the hoisting unit, then the telescopic rod 53 can be recovered, and the goods are put down slowly by the hoisting unit, so that the influence on the stability of the hoisting unit by the weightlessness of the goods caused by direct falling of the goods when the telescopic rod 53 is directly recovered can be avoided. The hoisting unit has a stall protection function, so deviation of the center of gravity will not be generated in the hoisting process.

To facilitate the transfer or hoisting of materials with different specifications, the bearing rod is in sliding connection with the base, or the base is provided with several mounting holes, so that the distance between two bearing rods can be adjusted manually or automatically when the bearing rods are mounted on the base, and the spacing in a width direction of the bearing rod can be adjusted conveniently for materials with different sizes. This is a conventional technical means in this field, which will not be traced back here.

As shown in FIG. 6, in this embodiment, the hoisting unit includes a winch 6 arranged on the support 2, a pulling rope 61 is arranged on the winch 6, and a hoisting hook or a hoisting ring is arranged on an end part of the pulling rope 61. The pulling rope 61 adopts multiple sections, which are respectively wound on the winch 6. The multi-section pulling rope 61 is provided, so that after the goods are hoisted to a specific place, the pulling rope 61 is released, one end of the pulling rope 61 is connected to the goods, and the other end of the pulling rope can be fixed on a bridge deck or float on the water, thereby positioning the pulling rope 61. When it is necessary to recover the goods, the telescopic rod 53 or the hoisting unit can hook up a positioning end of the pulling rope 61, thereby recovering the pulling rope 61 to the winch 6 and hoisting the goods from a lower place after the hoisting unit is reversed. To avoid the inference between the pulling rope 61 and the telescopic rod 53, the end part of the pulling rope 61 extends out of the bearing seat 51. A guide wheel 63 for guiding the pulling rope 61 is arranged on the base 3 and/or the bearing rod 52. In the goods transportation process, to prevent the materials from falling from the side, baffles 31 are symmetrically arranged on the base 3.

The hoisting unit on the bearing rod 52 is configured to hoist materials through the winch 6, thereby facilitating the downward hoisting of materials on a bridge or a high-rise for underwater operation or aloft work. Due to the design of the hoisting unit, the rescue scenario of the robot is further expanded. In particular, for emergency water intake or fire-fighting water intake of the bridge deck, a water pump can be directly hoisted to the underwater operation. Furthermore, a plurality of water pumps can be carried back and forth. Compared with the original integrated robot and water pump, the application range is wider, the cost is lower, and the function of carrying materials is not affected.

The working process of the present invention is as follows: the second track 46 of the robot is turned over to be docked with the first track 45 first, then the relative positions of the second track 46 and the first track 45 are locked, the materials are fixed by the limiting block 56 on the telescopic rod 53, at this time, the electromagnet is turned on to adsorb the materials only on the limiting block 56, and the hoisting portion 62 of the pulling rope 61 is fixed with the materials manually or automatically to complete the loading of the materials; and the traveling unit 1 is started through remote control or a set program, the materials are conveyed to a set emergency point, and the materials can be lifted by the lifting mechanism 42 and extended by the telescopic mechanism if there are articles in the way.

Specifically, when this embodiment is applied to water intake and drainage of the bridge deck, the materials (the materials during water intake and drainage are water pumps) can be lifted by the lifting mechanism 42 to cross the fence of the bridge deck in the height direction and then are extended out by the telescopic mechanism, and the pulling rope 61 is tightened by the hoisting unit at this time, so that all the weight of the materials is borne by the pulling rope 61; then the electromagnetic is de-energized, so that the materials are not adsorbed on the electromagnet, thereby ensuring that the materials are hoisted to extend out of the part above the bridge deck; and based on this, the winch 6 rotates slowly and drives the pulling rope 61 to slowly put the materials into water. After the materials are put into water, the other end of the pulling rope 61 can be separated from the winch 6 to float on the water surface or be fixed on the bridge deck, thereby ensuring that the pulling rope 61 can be found when the materials are wanted to be recovered; and then the transfer robot returns to the initial position of operation to perform next transfer.

When it is necessary to recover the materials, the robot travels to the set position by the traveling unit 1, and the lifting mechanism 42 is lifted to extend out of the telescopic mechanism so as to cross the bridge deck in the height; the telescopic mechanism extends out of the bridge deck, a hook or clip arranged on the end part of the pulling rope 61 hooks or absorbs the pulling rope 61 at the other ends of the materials that have been transported in place, the pulling rope 61 is rolled by the winch 6, so that the materials are lifted off the water surface, and the materials are slowly lifted to the highest point; at this time, the electromagnet is energized to adsorb the materials to position the materials, thereby preventing the materials from shaking; and after the materials are recovered, the traveling unit 1 is controlled to a safe place to unload the materials.

The multifunctional transfer robot is provided with a traveling mechanism, so that unmanned operation of carrying emergency rescue materials is implemented; the lifting unit 4 and a telescopic mechanism are provided, so that the transport specification of transport relief materials is expanded; and the hoisting unit is provided for hoisting, is conveniently applied to carrying occasions with a large height difference, and can be reused, thereby facilitating the multi-thread operation of one robot and improving the loading efficiency.

The specific embodiments described herein are merely intended to illustrate the spirit of the present invention. A person skilled in the art can make various modifications or supplements to the specific embodiments described or replace them in a similar manner, but it may not depart from the spirit of the present invention or the scope defined by the appended claims.

1. A multifunctional transfer robot, comprising a traveling unit, wherein a support is arranged on the traveling unit;
a base is arranged on the support, and a lifting unit capable of driving the base to ascend and descend in a height direction is arranged between the support and the base;
a bearing seat for bearing materials is arranged on the base; and
a winch is further arranged on the support, and the winch is arranged at one end of the support away from the bearing seat.

2. The multifunctional transfer robot according to claim 1, wherein a pulling rope is arranged on the winch, one end of the pulling rope is wound on the winch, a second end of the pulling rope is provided with a hoisting portion, the bearing seat is provided with a pivot, the pulling rope passes through or goes around the pivot to be connected to the hoisting portion, and a guide wheel is arranged on the pivot.

3. The multifunctional transfer robot according to claim 1, wherein a water hose is arranged on the winch, one end of the water hose is wound on the winch, and a second end of the water hose is a free end.

4. The multifunctional transfer robot according to claim 1, wherein the traveling unit comprises a traveling mechanism and a power mechanism for driving the traveling mechanism to move, the power mechanism is a motor, a hydraulic motor or an internal combustion engine, and the traveling mechanism is a crawler type traveling chassis or a tire type traveling chassis.

5. The multifunctional transfer robot according to claim 1, wherein the lifting unit comprises guide rails arranged on the support and a lifting mechanism for driving the base to move up and down along the guide rails; and the lifting mechanism comprises a hydraulic cylinder, a piston of the hydraulic cylinder is fixedly connected to the base, and a hydraulic cylinder mounting base is arranged on the support.

6. The multifunctional transfer robot according to claim 5, wherein two groups of the guide rails are respectively arranged on two sides of the support, and a guide piece embeddable in the guide rails is arranged on the base.

7. The multifunctional transfer robot according to claim 6, wherein each of the guide rails is foldable and comprises a first track connected to the base and a second track hinged with the first track, a limiting piece for limiting when the second track is turned over to be docked with the first track is arranged between the first track and the second track, guide grooves are formed in the first track and the second track, and the guide groove in the second track is docked with the guide groove in the first track when the second track is turned over to be docked with the first track.

8. The multifunctional transfer robot according to claims 1, wherein the bearing seat comprises a bearing rod arranged on the base, one end of the bearing rod is fixedly connected to the base, and a second end of the bearing rod is provided with an electromagnet.

9. The multifunctional transfer robot according to claim 8, wherein a multi-stage telescopic mechanism is arranged on the bearing rod, the multi-stage telescopic mechanism comprises a telescopic rod arranged on the bearing rod away from the one end of the bearing rod fixedly connected to the base, the telescopic rod is capable of extending forward or retracting backward in an extending direction of the bearing rod, and the multi-stage telescopic mechanism further comprises a telescopic power module arranged on the bearing rod.

10. The multifunctional transfer robot according to claim 9, wherein the telescopic power module comprises a hydraulic cylinder arranged on the bearing rod, an output shaft of the hydraulic cylinder is connected to the telescopic rod, the telescopic power module further comprises a limiting block arranged on the telescopic rod, the limiting block comprises a supporting block and a centering block arranged on the supporting block, a front part of the centering block is conical or arc-shaped, and the supporting block is larger than the centering block.

11. A hoisting method of a multifunctional transfer robot, comprising the following steps:
S1: firstly, through traveling of a traveling unit, locating an electromagnet on a bearing rod below a hoisted material, energizing the electromagnet, and descending the bearing rod through the ascending and descending of a lifting mechanism until the electromagnet adsorbs the hoisted material;
S2: fixing a hoisting portion on the hoisted material to fix the hoisted material;
S3: rotating a winch until a pulling rope tightens the hoisted material;
S4: after transporting the hoisted material to a working area by the traveling unit, lifting the hoisted material by the lifting mechanism in a height direction until the hoisted material is higher than an obstacle;
S4: extending a telescopic mechanism, so that the hoisted material extends forward in a plane direction to cross the obstacle;
S5: rotating the winch, and after the pulling rope tightens the hoisted material again, de-energizing the electromagnet, wherein the gravity of the hoisted material is borne by the pulling rope at this time;
S6: driving the pulling rope by the winch to move down to make the hoisted material fall to a rescue area;
S7: after the falling of the hoisted material is completed, requiring the pulling rope to be separated from the winch to complete hoisting, where the pulling rope on the winch is longer than a height difference of the rescue area; and
S8: recovering the telescopic mechanism, descending the a lifting unit, and conveying the multifunctional transfer robot by the traveling unit to a next station for use.

12. The hoisting method of a multifunctional transfer robot according to claim 11, wherein the pulling rope is segmented, and one end of the pulling rope away from the hoisting portion is provided with a recovering portion.

13. The hoisting method of a multifunctional transfer robot according to claim 12, further comprising a recovering step as follows:
S9: driving the multifunctional transfer robot by the traveling unit to enter a recovering area, lifting the lifting mechanism, extending the telescopic mechanism, and moving down the pulling rope by the winch;
S10: after the hoisting portion on the pulling rope is in contact with the recovering portion on the hoisted material, fixing the recovering portion on the hoisting portion through strong magnetic adsorption or a lifting hook, then recovering the winch, rewinding the recovering portion on the winch, energizing the electromagnet after lifting the hoisted material to the bearing rod, and making the hoisted material re-adsorbed on the electromagnet; and
S11: recovering the telescopic mechanism, descending the lifting unit, and transporting the hoisted material by the traveling unit to an initial position to complete the recovery of the hoisted material.

14. The multifunctional transfer robot according claim 2, wherein the bearing seat comprises a bearing rod arranged on the base, one end of the bearing rod is fixedly connected to the base, and a second end of the bearing rod is provided with an electromagnet.

15. The multifunctional transfer robot according to claim 14, wherein a multi-stage telescopic mechanism is arranged on the bearing rod, the multi-stage telescopic mechanism comprises a telescopic rod arranged on the bearing rod away from the one end of the bearing rod fixedly connected to the base, the telescopic rod is capable of extending forward or retracting backward in an extending direction of the bearing rod, and the multi-stage telescopic mechanism further comprises a telescopic power module arranged on the bearing rod.

16. The multifunctional transfer robot according to claim 15, wherein the telescopic power module comprises a hydraulic cylinder arranged on the bearing rod, an output shaft of the hydraulic cylinder is connected to the telescopic rod, the telescopic power module further comprises a limiting block arranged on the telescopic rod, the limiting block comprises a supporting block and a centering block arranged on the supporting block, a front part of the centering block is conical or arc-shaped, and the supporting block is larger than the centering block.

17. The multifunctional transfer robot according claim 3, wherein the bearing seat comprises a bearing rod arranged on the base, one end of the bearing rod is fixedly connected to the base, and a second end of the bearing rod is provided with an electromagnet.

18. The multifunctional transfer robot according to claim 17, wherein a multi-stage telescopic mechanism is arranged on the bearing rod, the multi-stage telescopic mechanism comprises a telescopic rod arranged on the bearing rod away from the one end of the bearing rod fixedly connected to the base, the telescopic rod is capable of extending forward or retracting backward in an extending direction of the bearing rod, and the multi-stage telescopic mechanism further comprises a telescopic power module arranged on the bearing rod.

19. The multifunctional transfer robot according to claim 18, wherein the telescopic power module comprises a hydraulic cylinder arranged on the bearing rod, an output shaft of the hydraulic cylinder is connected to the telescopic rod, the telescopic power module further comprises a limiting block arranged on the telescopic rod, the limiting block comprises a supporting block and a centering block arranged on the supporting block, a front part of the centering block is conical or arc-shaped, and the supporting block is larger than the centering block.

20. The multifunctional transfer robot according claim 4, wherein the bearing seat comprises a bearing rod arranged on the base, one end of the bearing rod is fixedly connected to the base, and a second end of the bearing rod is provided with an electromagnet.
